(19) United States
(12) Patent Application Publication
(10) Pub. No.: US 2003/0231489 A1
(43) Pub. Date: Dec. 18, 2003

(54) Coupling system for securing an illuminating light to a cap visor

(76) Inventor: Yu-Teng Hsiao, Chia Yi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/173,407

(22) Filed: Jun. 18, 2002

(51) Int. Cl. F21V 21/084

(52) U.S. Cl. 362/106; 362/103; 362/105

(57) ABSTRACT

A coupling system for securing an illuminating light to a cap visor includes one coupling piece with at least one magnetic article inlaid in the cap visor and one coupling block with at least one magnetic article therein so as for the coupling block convenient to be securely coupled to the cap visor by the mutual magnetic attractive force of the at least one magnetic article inlaid in the coupling piece and the at least one magnetic article in the coupling block. In the bottom of the coupling block is pivotally connected with a pivotal connector, and in the bottom of the pivotal connector is provided with a hollow for receiving a jointing ball on the top of an illuminating light which can be adjusted to proper degrees for illumination.

### BACKGROUND OF THE INVENTION

1. Field of the Invention

This invention relates to a coupling system for securing an illuminating light to a cap visor, and more particularly to a coupling system which includes one coupling piece with at least magnetic article inlaid in the cap visor and one coupling block with at least one magnetic article therein and pivotally connected with an illuminating light so as for the coupling block as well as the illuminating light convenient to be securely coupled to the cap visor by the mutual magnetic attractive force of the at least one magnetic article inlaid in the coupling piece of the cap visor and the at least one magnetic article in the coupling block

2. Description of the Related Art

Modern people always take an part in activities, such as fishing, sight-seeing, mountain-climbing, at night. Some people must work at night or at dark places. Therefore, illuminating lights are indispensable for those people who take an part in activities or work at night or at dark places. However, a common illuminating light is heavy so that it is not convenient and troublesome for a person to carry an common illuminating light while doing activities or working. Moreover, an common illuminating light must be carried at least by one hand of a user so as to cause much trouble to the user.

### SUMMARY OF THE INVENTION

Therefore, the present invention is to provide a coupling system for securing an illuminating light to a cap visor that substantially obviates the drawbacks of the related conventional illuminating light.

An objective of the present invention is to provide a coupling system which includes one coupling piece with at least magnetic article inlaid in the cap visor and one coupling block with at least one magnetic article therein and pivotally connected with an illuminating light.

Another objective of the present invention is to provide a coupling system which can make the coupling block as well as the illuminating light convenient to be securely coupled to the top surface or bottom surface of a cap visor by the mutual magnetic attractive force of the at least one magnetic article inlaid in the coupling piece of the cap visor and the at least one magnetic article in the coupling block without being carried by hands.

Yet another objective of the present invention is to provide a coupling system for securing an illuminating light to a cap visor whose illuminating light is pivotally provided at the bottom of the coupling block and can be adjusted to proper degrees for illumination.

Accordingly, a coupling system in the present invention is provided for securing an illuminating light to a cap visor. The coupling system includes one coupling piece with at least one magnetic article inlaid in the cap visor and one coupling block with at least one magnetic article therein so as for the coupling block convenient to be securely coupled to the top surface or bottom surface of the cap visor by the mutual magnetic attractive force of the at least one magnetic article inlaid in the coupling piece of the cap visor and the at least one magnetic article in the coupling block. In the bottom of the coupling block is pivotally connected with a pivotal connector by a screw, and in the bottom of the pivotal connector is provided with a semicircular hollow for receiving a jointing ball on the top of an illuminating light which can be adjusted to proper degrees for illumination.

### BRIEF DESCRIPTION OF THE DRAWINGS

Other features and advantages of the present invention will become apparent in the following detailed description of the preferred embodiments with reference to the accompanying drawings, in which:

FIG. 1 is an exploded perspective view of the cap visor and the illuminating light with the coupling system in accordance with the present invention;

FIG. 2 is a front elevation view of the cap visor and the illuminating light with the coupling system in a coupled configuration in accordance with the present invention;

FIG. 3 is a side sectional view of the illuminating light being coupled to the bottom of the cap visor in accordance with the present invention;

FIG. 4 is a side sectional view of the illuminating light being coupled to the top of the cap visor in accordance with the present invention;

FIG. 5 is a side elevation schematic view of the illuminating light with the coupling system being adjusted to a predetermined position by the pivotal connector in accordance with the present invention;

FIG. 6 is a front elevation schematic view of the illuminating light with the coupling system being turned around by the jointing ball in accordance with the present invention; and,

FIG. 7 is a side elevation schematic view of the illuminating light whose light shell being turned to switch on or off in accordance with the present invention.

### DETAILED DESCRIPTION OF THE PREFERRED EMBODIMENTS

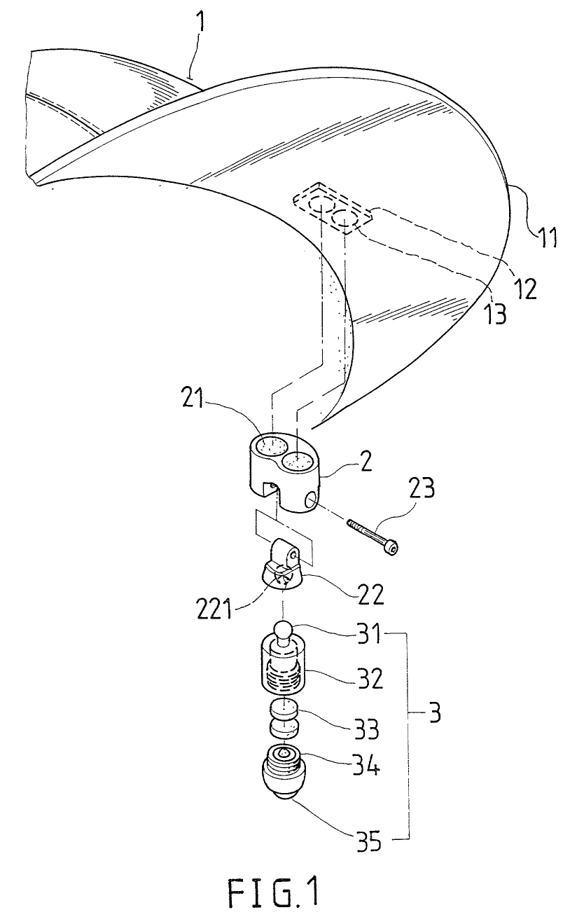

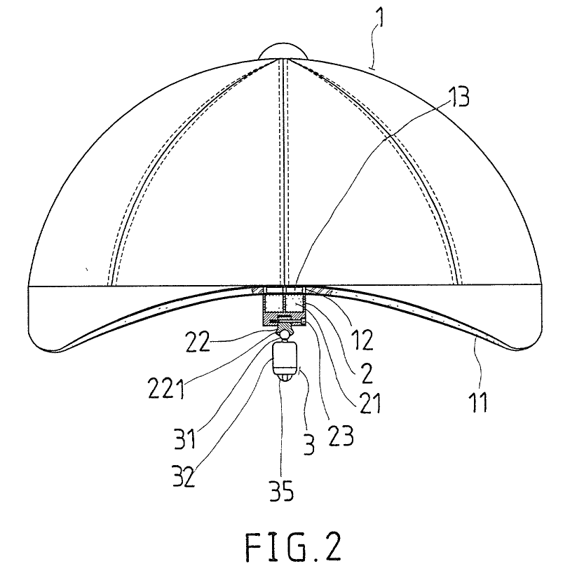

Referring to FIGS. 1 and 2, the present invention is provided with a coupling system for securing an illuminating light 3 to a visor 11 of a cap 1. The coupling system includes one coupling piece 12 and one coupling block 2. The coupling piece 12 is provided with at least one magnetic article 13 and inlaid in a predetermined position of the cap visor 11.

The coupling block 2 is provided with at least one magnetic article 21 in the top section so as to be magnetically coupled to the bottom end or the top end of the at least one magnetic article 13 in the coupling piece 12 by the mutual magnetic attractive force. A pivotal connector 22 is pivotally provided in the bottom of the coupling block 2 by a screw 23, and a semicircular hollow 221 is provided in the bottom of the pivotal connector 22 so as to receive a jointing ball 31 on the top end of the cover 32 of the illuminating light 3. In the illuminating light 3 are provided with batteries 33, a screwing section 34 and an LED bulb 35.

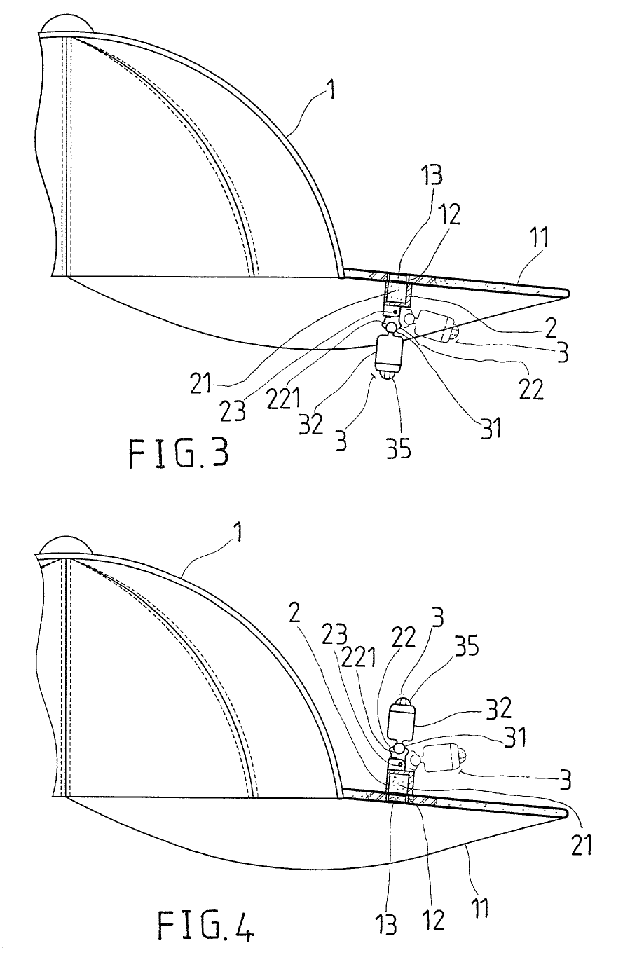

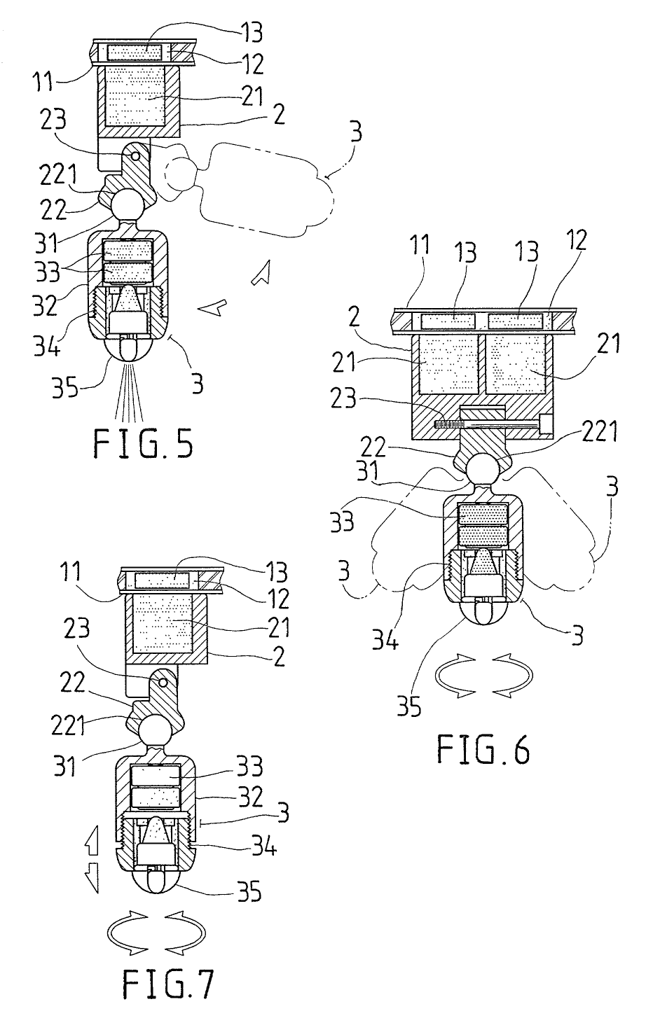

While being applied, after the cap 1 being worn on a wearer's head, the coupling block 2 as well as the illuminating light 3 is magnetically coupled to the bottom end or the top end of the at least one magnetic article 13 in the coupling piece 12 of the cap visor 11 by the strong mutual magnetic attractive force of the at least one magnetic article 12 inlaid in the cap visor 11 and the at least one magnetic article 21 in the coupling block 2, as shown in FIGS. 3 and 4, and then the screwing section 34 of the illuminating light 3 is screwed to switch on the LED bulb 35 for illumination, as shown in FIG. 5.

While the illuminating light 3 with the coupling system in the present invention being secured to the cap visor 11, the pivotal connector 22 in the bottom of the coupling block 2 can be adjusted to a predetermined degree for better illumination, referring to FIG. 5, and the illuminating light 3 can be turned by the jointing ball 31 pivotally inlaid in the semicircular hollow 221 of the pivotal connector 22 to have better illumination, referring to FIG. 6. When the screwing section 34 of the illuminating light 3 is unscrewed, the LED bulb 35 will be switched off, referring to FIG. 7.

Besides, it is convenient for the coupling block 2 to be apart from the cap visor 11.

While the preferred embodiments of the invention have been described above, it will be recognized and understood that various modifications may be made therein, and the appended claims are intended to cover all such modifications which may fall within the spirit and scope of the invention.

What is claimed is:

1. A coupling system for securing an illuminating light to a cap visor comprising:
one coupling piece being provided with at least one magnetic article and inlaid in a predetermined position of the cap visor; and,
one coupling block being provided with at least one magnetic article in the top section so as to be magnetically coupled to the bottom end or the top end of said at least one magnetic article in said coupling piece by the mutual magnetic attractive force, a pivotal connector being pivotally provided in the bottom of said coupling block by a screw, a hollow being provided in the bottom of said pivotal connector so as to receive a jointing ball on the top end of the cover of an illuminating light, in said illuminating light being provided with batteries, a screwing section and an LED bulb, said screwing section being screwed or unscrewed to switch on or off said LED bulb, said pivotal connector in the bottom of said coupling block able to be adjusted to predetermined degrees for better illumination, and said illuminating light able be turned by said jointing ball pivotally inlaid in said hollow of said pivotal connector to have better illumination.
